(19) United States
(12) Patent Application Publication
(10) Pub. No.: US 2011/0121054 A1
(43) Pub. Date: May 26, 2011

(54) SOLDER MATERIAL OVERFLOW PREVENTATIVE METAL PLATE MEMBER FIXATION DEVICE INSTALLATION METHOD

(76) Inventor: Ming-Chung CHIU, Keelung City (TW)

(21) Appl. No.: 12/624,054

(22) Filed: Nov. 23, 2009

(51) Int. Cl. B23K 37/04; B23K 37/06

(52) U.S. Cl. 228/44.3

(57) ABSTRACT

A solder material overflow preventive metal plate member fixation device installation method includes the step of preparing a barrel and inserting the barrel into a mounting through hole on a metal plate member to abut a bottom bonding surface of the barrel against a solder material at the metal plate member, the step of press-fitting a solder mask insert into the barrel to keep the solder mask insert in flush with the bottom edge of the barrel for stopping a solder material from flowing into the barrel, the step of bonding the barrel to the metal plate member through a soldering process, and the step of removing the solder mask insert from the barrel after the soldering process.

### BACKGROUND OF THE INVENTION

1. Field of the Invention

The present invention relates to the application of a metal plate member fixation device for joining a metal plate member to a shell and more particularly, to a solder material overflow preventive metal plate member fixation device installation method, which prevents overflow of the melted solder material during the bonding operation, assuring high installation quality.

2. Description of the Related Art

When fastening plate members together, a positioning screw formed of a knob, a ring and a screw nail is usually used. During installation, the screw nail and the ring are secured to the first plate member, and then the knob is rotated to drive the screw nail into the second plate member, and then a hand tool is used to fasten tight the screw nail, affixing the first and second plate members together. This plate member joining method can be used in a machine tool to join plate members together.

The power drive and speed-adjustment unit of a machine tool are generally provided inside the shell (housing). To facilitate repair of a machine tool or adjustment of the output speed of a machine tool, a detachable plate member is usually provided at the shell (housing) of the power drive or speed-adjustment unit. Screw bolts are commonly used to fasten the movable plate member to the housing. When unfastening screw bolts to dismount a movable plate member from the housing, the associating lock nuts may fall from the screw bolts. This movable plate member mounting and dismounting procedure is complicated, wasting much time and labor.

There is known a metal plate member fixation device comprised of a cap, a screw bolt, a spring member and a barrel for joining two metal plate members together. After fixation of the barrel of the metal plate member fixation device to a through hole on a first plate member, the screw bolt is threaded into a screw hole on a second plate member to secure the first plate member and the second plate member together. Because the barrel of the metal plate member fixation device is kept secured to the first plate member after removal of the first plate member from the second plate member, the metal plate member fixation device will not be missed by accident. Further, an automatic machine may be used to pick up the barrel and to insert the barrel into the mounting through hole on the first metal plate member for quick bonding of the barrel to the first metal plate member with a solder material through a reflow soldering process. After bonding of the barrel to the first metal plate member, the automatic machine is operated against to pick up the assembly of the cap, the screw bolt and the spring member and to couple the cap to the barrel.

The barrel may be prepared from stainless steel. Alternatively, the barrel may be prepared from any other metal material and processed through a surface treatment (electroplating or chemical plating). Due to the solder resistant surface characteristic of the barrel, a solder material must be used to facilitate bonding of the barrel to the first metal plate member. When bonding the barrel to the first metal plate member, the melted solder material may flow into the inside of the barrel subject to the siphon effect, clogging the opening of the barrel or causing deformation of the barrel. When an overflow of the solder material happens, the solder material may be not sufficiently filled in between the outside wall of the barrel and the peripheral wall of the mounting through hole of the first metal plate member, lowering the bonding strength between the barrel and the first metal plate member and installation quality.

Therefore, it is desirable to provide a metal plate member fixation device installation method that eliminates overflow of the solder material during the bonding operation.

### SUMMARY OF THE INVENTION

The present invention has been accomplished under the circumstances in view. It is therefore an object of the present invention to provide a solder mask overflow preventive metal plate member fixation device installation method, which prevents overflow of the solder material during the bonding operation, assuring a high level of installation quality.

To achieve this and other objects of the present invention, a solder mask overflow preventive metal plate member fixation device installation method comprises the steps of preparing a barrel and inserting the barrel into a mounting through hole on a metal plate member to abut a bottom bonding surface of the barrel against a solder material at the metal plate member; press-fitting a solder mask insert into the barrel to keep the solder mask insert in flush with the bottom edge of the barrel for stopping a solder material from flowing into the barrel; bonding the barrel to the metal plate member through a soldering process; and removing the solder mask insert from the barrel after the soldering process.

In an alternate form of the present invention, a cap is fastened to the head of a lock screw and a spring member is sleeved onto the lock screw after bonding of the barrel to the metal plate member and fore removing of the solder mask insert from the barrel, and then the lock screw is inserted into the barrel to have the spring member be stopped between a part of the barrel and the head of the lock screw, and then the cap is coupled to the barrel. By means of moving the cap relative to the barrel, the lock screw is forced against the solder mask insert to push the solder mask insert out of the barrel.

Further, the solder mask can be processed through a surface treatment to provide an anti-skid surface layer for friction engagement with the inside wall of the barrel to prevent displacement of the solder mask insert relative to the barrel. Further, the anti-skid surface layer can be made having an embossed pattern, evenly distributed raised portions or fine teeth, evenly distributed ribs, intersected ribs or the like. Further, the solder mask insert can be shaped like a circular block or T-bar.

### BRIEF DESCRIPTION OF THE DRAWINGS

FIG. 1 is a flow chart of a solder material overflow preventive metal plate member fixation device fixation method in accordance with the present invention.

FIG. 2 is an exploded view of a barrel and a solder mask insert in accordance with the present invention.

FIG. 3 is a schematic exploded view in section of the present invention before installation of the solder mask insert in the barrel and bonding of the barrel to a metal plate member.

FIG. 4 corresponds to FIG. 3, showing the barrel inserted into the mounting through hole of the metal plate member before bonding.

FIG. 5 is a flow chart of an alternate form of the solder material overflow preventive metal plate member fixation device fixation method in accordance with the present invention.

FIG. 6 is an exploded view of a metal plate member fixation device used in the solder material overflow preventive metal plate member fixation device fixation method according to the present invention.

FIG. 7 corresponds to FIG. 6, showing the barrel fastened to a metal plate member before installation of the lock device and the spring member in the barrel.

FIG. 8 corresponds to FIG. 7, showing the solder mask insert forced out of the barrel before installation of the metal plate member to a shell.

FIG. 9 corresponds to FIG. 8, showing the metal plate member locked to the shell.

FIG. 10 is a sectional side view of still another alternate form of the present invention

### DETAILED DESCRIPTION OF THE PREFERRED EMBODIMENT

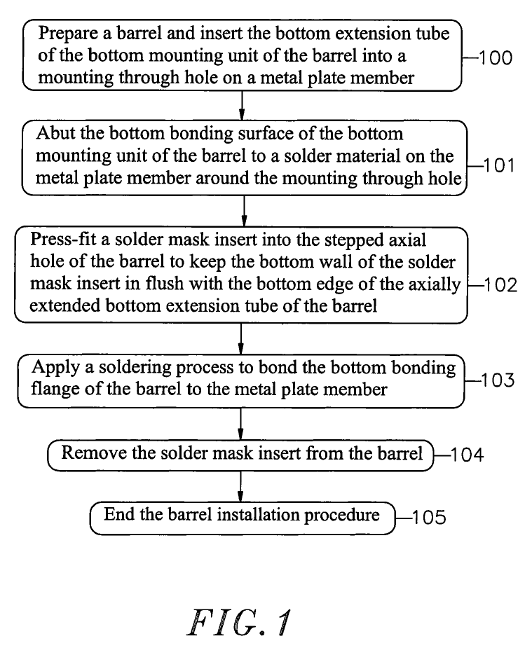

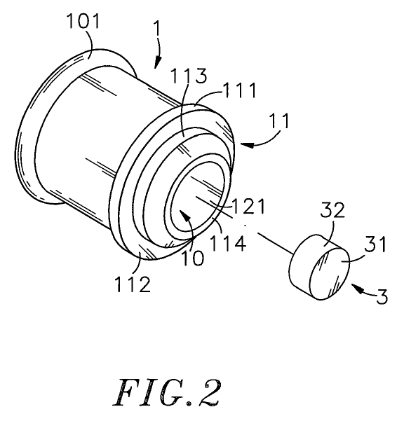

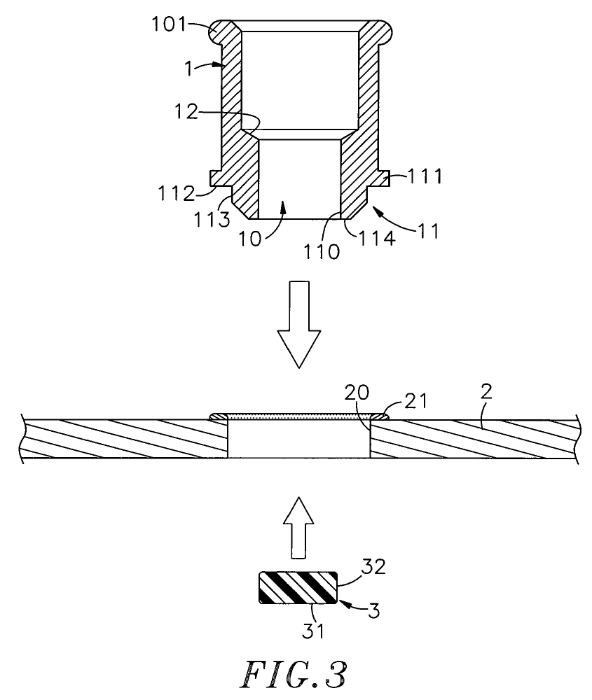

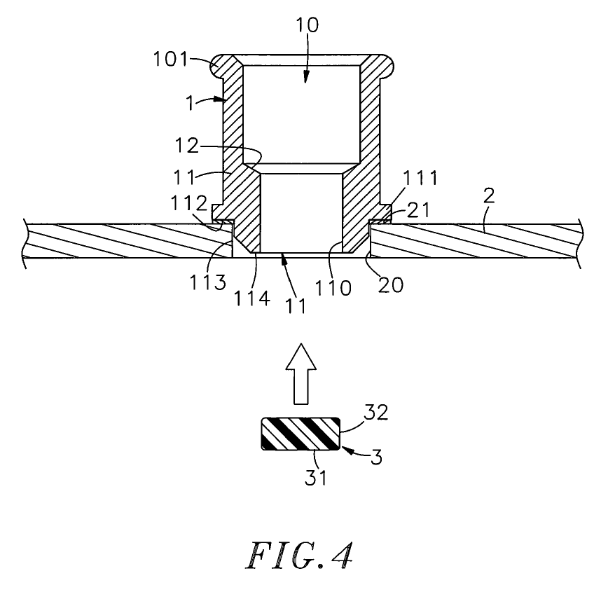

Referring to FIGS. 1-4, a solder material overflow preventive metal plate member fixation device installation method in accordance with the present invention includes the following steps:
(100) Prepare a barrel 1 that comprises a top coupling flange 101, a bottom mounting unit 11 having a radially extended bottom bonding flange 111 and an axially extended bottom extension tube 113, a stepped axial hole 10;110 formed of a relatively wider upper axial hole section 10 and a relatively narrower lower axial hole section 110 and axially extending through top and bottom sides thereof and a step 12 extending around the inside wall between the relatively wider upper axial hole section 10 and the relatively narrower lower axial hole section 110, and then aim the bottom extension tube 113 of the bottom mounting unit 11 of the barrel 1 at a mounting through hole 20 of a metal plate member 2;
(101) Insert the bottom extension tube 113 of the bottom mounting unit 11 of the barrel 1 into a mounting through hole 20 of a metal plate member 2 to stop the bottom bonding surface 112 of the radially extended bottom bonding flange 111 against a solder material 21 being applied to the top surface of the metal plate member 2 around the mounting through hole 20;
(102) Press-fit an solder mask insert 3 into the relatively narrower lower axial hole section 110 of the barrel 1 to force the periphery 32 of the solder mask insert 3 into friction engagement with the inside wall of the bottom extension tube 113 and to keep the bottom wall 31 of the solder mask insert 3 in flush with the bottom edge 114 of the bottom extension tube 113;
(103) Apply a soldering process to bond the bottom bonding flange 111 of the barrel 1 to the metal plate member 2 where the solder mask insert 3 stops the melted solder material 21 from entering the relatively narrower lower axial hole section 110 of the barrel 1 to avoid deformation of the inside wall of the bottom extension tube 113 due to an excessively high melting temperature of the solder material 21;
(104) Pull the solder mask insert 3 out of the barrel 1 directly from the relatively narrower lower axial hole section 110 or through the relatively wider upper axial hole section 10 after bonding of the barrel 1 to the metal plate member 2;
(105) End the barrel 1 installation operation.

According to the present invention, the barrel 1 comprises a top coupling flange 12, a bottom mounting unit 11 having a radially extended bottom bonding flange 111 and an axially extended bottom extension tube 113, a stepped axial hole 10;110 formed of a relatively wider upper axial hole section 10 and a relatively narrower lower axial hole section 110 and axially extending through top and bottom sides thereof and a step 12 extending around the inside wall between the relatively wider upper axial hole section 10 and the relatively narrower lower axial hole section 110. Further, the step 12 is a beveled step sloping downwards in direction from the relatively wider upper axial hole section 10 toward the relatively narrower lower axial hole section 110. The axially extended bottom extension tube 113 extends axially from the bottom end of the barrel 1. The bottom bonding flange 111 extends radially around the periphery of the bottom end of the barrel 1. The bottom bonding surface 112 of the radially extended bottom bonding flange 111 expends perpendicular to the periphery of the axially extended bottom extension tube 113. During installation, the axially extended bottom extension tube 113 is inserted into the mounting through hole 20 of the metal plate member 2, and the bottom bonding surface 112 of the radially extended bottom bonding flange 111 is stopped against the solder material 21 that is applied to the top surface of the metal plate member 2 around the mounting through hole 20. Thereafter, the solder mask insert 3 is press-fitted into the relatively narrower lower axial hole section 110 of the barrel 1 to force the periphery 32 of the solder mask insert 3 into friction engagement with the inside wall of the bottom extension tube 113 and to keep the bottom wall 31 of the solder mask insert 3 in flush with the bottom edge 114 of the bottom extension tube 113. Further, the bottom wall 31 of the solder mask insert 3 is kept in flush with the bottom edge 114 of the bottom extension tube 113, preventing any gaps in between the solder mask insert 3 and the bottom extension tube 113. The periphery 32 of the solder mask insert 3 is processed through a surface treatment, assuring positive friction engagement between the solder mask insert 3 and the inside wall of the bottom extension tube 113 after insertion of the solder mask insert 3 into the bottom extension tube 113. Therefore, the solder mask insert 3 supports the barrel 1 against deformation upon a severe temperature change and will not be moved axially relative to the barrel 1 during the soldering process. After insertion of the barrel 1 into the metal plate member 2 and insertion of the solder mask insert 3 into the barrel 1, the barrel 1 with the solder mask insert 3 and the metal plate member 2 are sent to a reflow oven for reflow soldering. When the solder material 21 is melted, the melted solder material 21 is evenly distributed over the bottom bonding surface 112 of the radially extended bottom bonding flange 111, the outside wall of the bottom extension tube 113 and the inside wall of the metal plate member 2 around the mounting through hole 21. During the reflow soldering operation, the solder mask insert 3 stops the melted solder material 21 from flowing into the inside of the relatively narrower lower axial hole section 110 of the barrel 1, preventing clogging of the relatively narrower lower axial hole section 110 of the barrel 1 by the solder material 21 and avoiding damage of the melted solder material 21 to the inside wall of the bottom extension tube 113. Thus, the barrel 1 can be positively bonded to the metal plate member 2. After the bonding operation, the metal plate member 2 and the bonded barrel 1 are removed from the reflow oven and cooled down, and then the solder mask insert 3 is removed from the relatively narrower lower axial hole section 110 of the barrel 1 directly. Alternatively, the solder mask insert 3 can be pushed out of the barrel 1 through the relatively wider upper axial hole section 10. By means of the use of the solder mask insert 3, the invention prevents flowing of the melted solder material 21 into the relatively narrower lower axial hole section 110 of the barrel 1 to damage the inside wall of the bottom extension tube 113.

Further, the periphery 32 of the solder mask insert 3 can be processed through a surface treatment to provide an anti-skid surface layer. The anti-skid surface layer can be made having an embossed pattern, evenly distributed raised portions or fine teeth, evenly distributed ribs, intersected ribs or the like to provide proper anti-skid function so that the solder mask insert 3 is prohibited from axial displacement relative to the bottom extension tube 113 after its insertion into the bottom extension tube 113. Further, press-fitting the solder mask insert 3 into the relatively narrower lower axial hole section 110 of the barrel 1 does not damage the inside wall of the bottom extension tube 113. Further, the outside wall of the solder mask insert 3 can be processed through a solder mask treatment, preventing adherence of the solder material 21 during the reflow soldering operation.

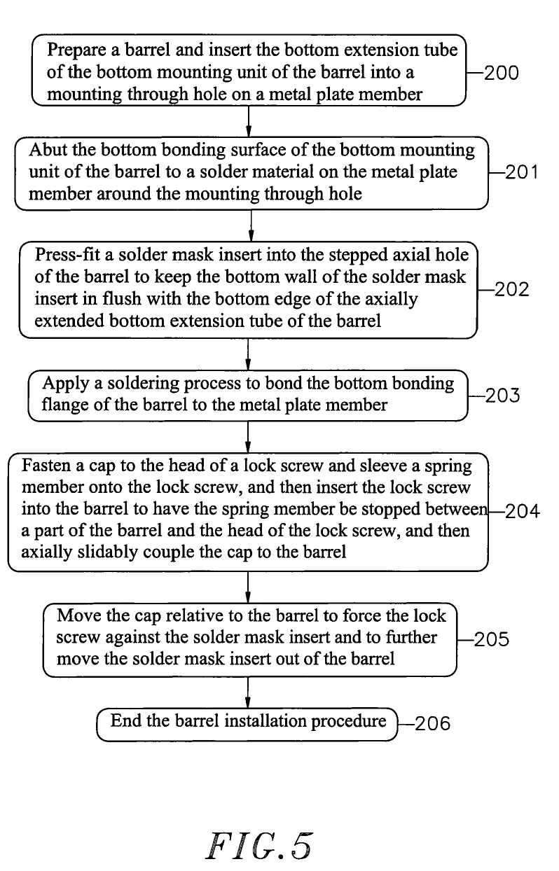

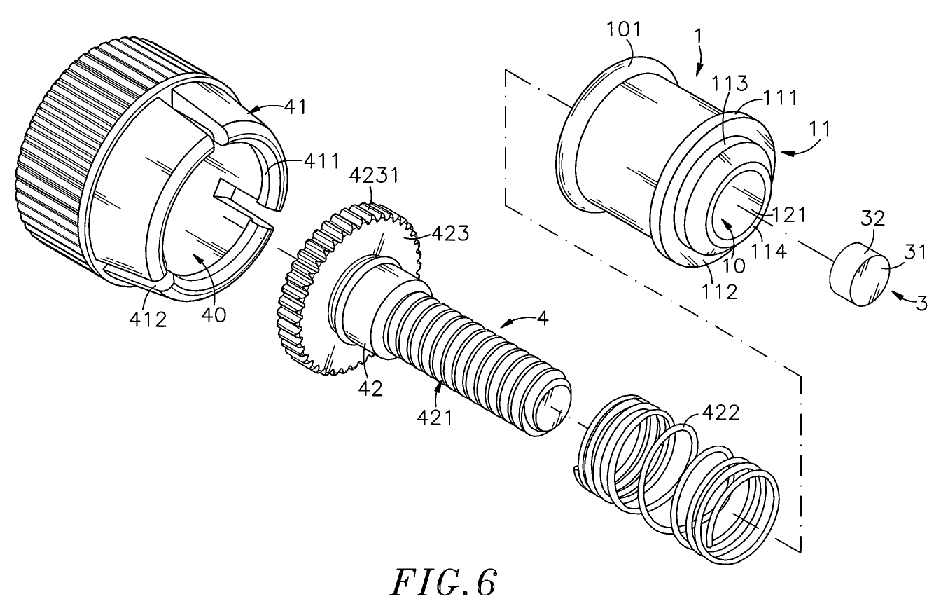

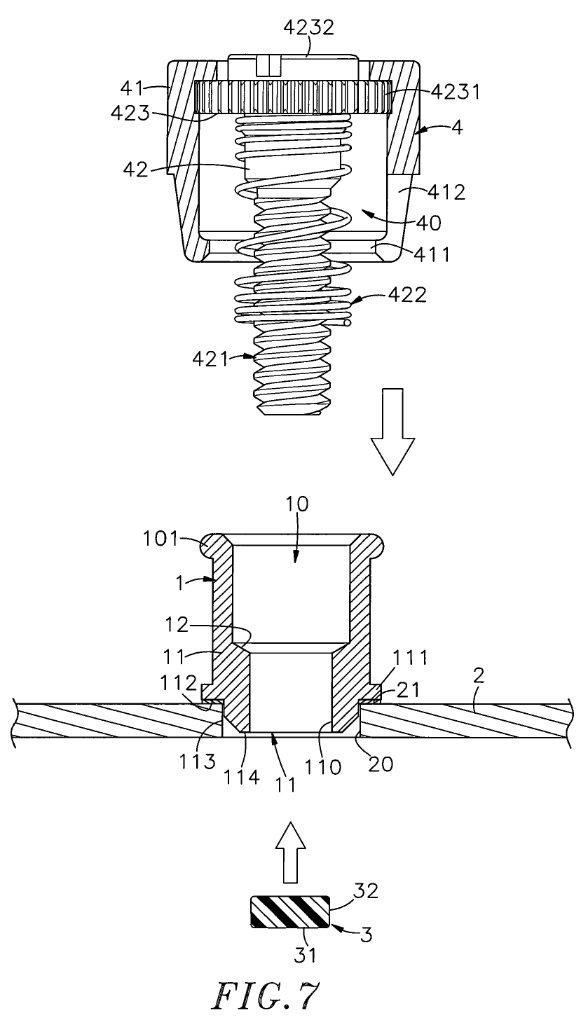

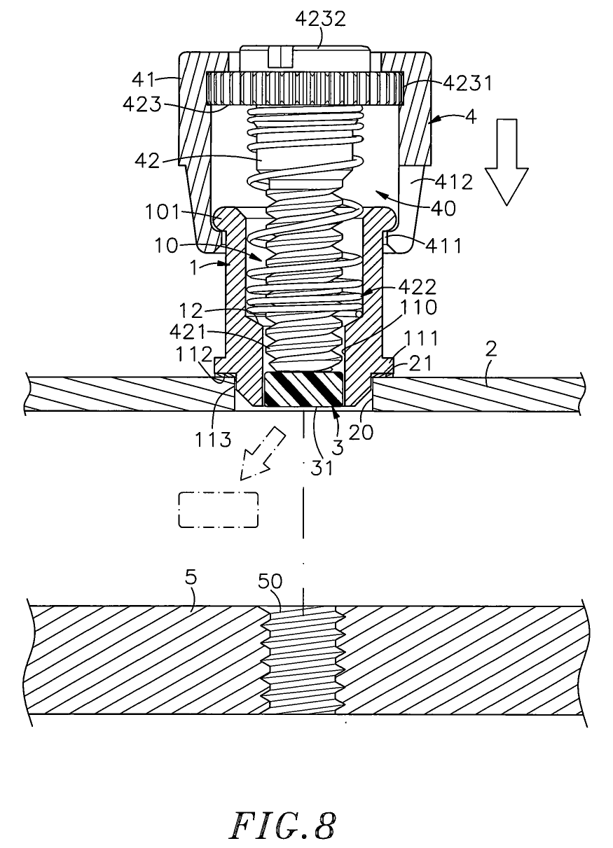

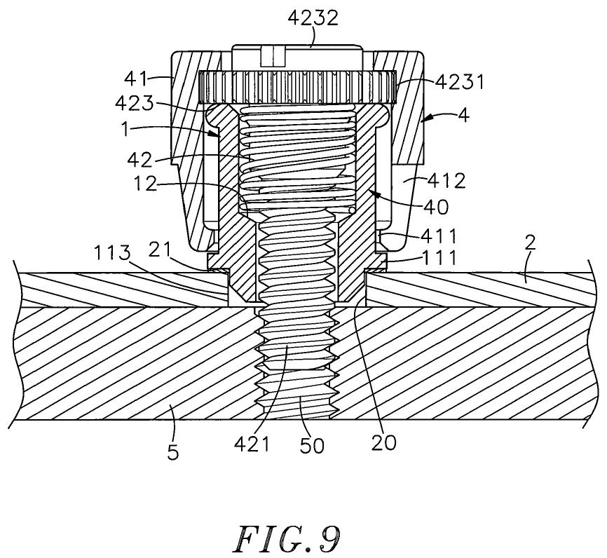

Referring to FIGS. 5-9, the solder material overflow preventive metal plate member fixation device installation method can be alternatively performed subject to the steps below:
(200) Prepare a barrel 1 that comprises a top coupling flange 101, a bottom mounting unit 11 having a radially extended bottom bonding flange 111 and an axially extended bottom extension tube 113, a stepped axial hole 10;110 formed of a relatively wider upper axial hole section 10 and a relatively narrower lower axial hole section 110 and axially extending through top and bottom sides thereof and a step 12 extending around the inside wall between the relatively wider upper axial hole section 10 and the relatively narrower lower axial hole section 110, and then aim the bottom extension tube 113 of the bottom mounting unit 11 of the barrel 1 at a mounting through hole 20 of a metal plate member 2;
(201) Insert the bottom extension tube 113 of the bottom mounting unit 11 of the barrel 1 into a mounting through hole 20 of a metal plate member 2 to stop the bottom bonding surface 112 of the radially extended bottom bonding flange 111 against a solder material 21 being applied to the top surface of the metal plate member 2 around the mounting through hole 20;
(202) Press-fit an solder mask insert 3 into the relatively narrower lower axial hole section 110 of the barrel 1 to force the periphery 32 of the solder mask insert 3 into friction engagement with the inside wall of the bottom extension tube 113 and to keep the bottom wall 31 of the solder mask insert 3 in flush with the bottom edge 114 of the bottom extension tube 113;
(203) Apply a soldering process to bond the bottom bonding flange 111 of the barrel 1 to the metal plate member 2 where the solder mask insert 3 stops the melted solder material 21 from entering the relatively narrower lower axial hole section 110 of the barrel 1 to avoid deformation of the inside wall of the bottom extension tube 113 due to an excessively high melting temperature of the solder material 21;
(204) Prepare a lock device 4, which comprises a lock screw 421 having a head 423 and a shoulder 42 at its one end, and a cap 41 that is fastened to the head 423 of the lock screw 421 and has an annular retaining portion 411 disposed at the free end and spaced around the lock screw 421, and then insert the lock screw 421 into the relatively wider upper axial hole section 10 of the barrel 1 to hold a spring member 422 between the shoulder 42 of the lock screw 421 and the step 12 of the barrel 1, and then axially slidably couple the annular retaining portion 411 of the cap 41 to the periphery of the barrel 1 for enabling the annular retaining portion 411 of the cap 41 to be stopped at the bottom side of the top coupling flange 101 of the barrel 1 subject to the effect of the spring force of the spring member 422;
(205) Move the cap 41 axially relative to the barrel 1 toward the metal plate member 2 to force the lock screw 421 against the solder mask insert 3 and to further push the solder mask insert 3 out of the barrel 1;
(206) End the barrel 1 installation operation.

According to this application example, the barrel 1 comprises a top coupling flange 12, a bottom mounting unit 11 having a radially extended bottom bonding flange 111 and an axially extended bottom extension tube 113, a stepped axial hole 10;110 formed of a relatively wider upper axial hole section 10 and a relatively narrower lower axial hole section 110 and axially extending through top and bottom sides thereof and a step 12 extending around the inside wall between the relatively wider upper axial hole section 10 and the relatively narrower lower axial hole section 110. Further, the step 12 is a beveled step sloping downwards in direction from the relatively wider upper axial hole section 10 toward the relatively narrower lower axial hole section 110. The axially extended bottom extension tube 113 extends axially from the bottom end of the barrel 1. The bottom bonding flange 111 extends radially around the periphery of the bottom end of the barrel 1. The bottom bonding surface 112 of the radially extended bottom bonding flange 111 expends perpendicular to the periphery of the axially extended bottom extension tube 113. During installation, the axially extended bottom extension tube 113 is inserted into the mounting through hole 20 of the metal plate member 2, and the bottom bonding surface 112 of the radially extended bottom bonding flange 111 is stopped against the solder material 21 that is applied to the top surface of the metal plate member 2 around the mounting through hole 20. Thereafter, the solder mask insert 3 is press-fitted into the relatively narrower lower axial hole section 110 of the barrel 1 to force the periphery 32 of the solder mask insert 3 into friction engagement with the inside wall of the bottom extension tube 113 and to keep the bottom wall 31 of the solder mask insert 3 in flush with the bottom edge 114 of the bottom extension tube 113. Further, the bottom wall 31 of the solder mask insert 3 is kept in flush with the bottom edge 114 of the bottom extension tube 113, preventing any gaps in between the solder mask insert 3 and the bottom extension tube 113. The periphery 32 of the solder mask insert 3 is processed through a surface treatment, assuring positive friction engagement between the solder mask insert 3 and the inside wall of the bottom extension tube 113 after insertion of the solder mask insert 3 into the bottom extension tube 113. Therefore, the solder mask insert 3 supports the barrel 1 against deformation upon a severe temperature change and will not be moved axially relative to the barrel 1 during the soldering process. After insertion of the barrel 1 into the metal plate member 2 and insertion of the solder mask insert 3 into the barrel 1, the barrel 1 with the solder mask insert 3 and the metal plate member 2 are sent to a reflow oven for reflow soldering. When the solder material 21 is melted, the melted solder material 21 is evenly distributed over the bottom bonding surface 112 of the radially extended bottom bonding flange 111, the outside wall of the bottom extension tube 113 and the inside wall of the metal plate member 2 around the mounting through hole 21. During the reflow soldering operation, the solder mask insert 3 stops the melted solder material 21 from flowing into the inside of the relatively narrower lower axial hole section 110 of the barrel 1, preventing clogging of the relatively narrower lower axial hole section 110 of the barrel 1 by the solder material 21 and avoiding damage of the melted solder material 21 to the inside wall of the bottom extension tube 113. Thus, the barrel 1 can be positively bonded to the metal plate member 2.

After the bonding operation, the metal plate member 2 and the bonded barrel 1 are removed from the reflow oven and cooled down. Thereafter, prepare a lock device 4, which comprises a lock screw 421 and a cap 41. The lock screw 421 has a head 423 and a shoulder 42 at its one end. The head 423 has an engagement portion 4231 located on the periphery. The cap 41 defines an open chamber 40. Further, the cap 41 has an annular retaining portion 411 disposed at the free end and spaced around the lock screw 421. The cap 41 is fixedly fastened to the engagement portion 4231 of the head 423 of the lock screw 421. Thereafter, sleeve the spring member 422 onto the lock screw 421, and then insert the lock screw 421 into the relatively wider upper axial hole section 10 of the barrel 1 to hold the spring member 422 between the shoulder 42 of the lock screw 421 and the step 12 of the barrel 1, and then axially slidably couple the annular retaining portion 411 of the cap 41 to the periphery of the barrel 1 at the metal plate member 2. After coupling of the cap 41 to the barrel 1, the spring member 422 pushes the lock screw 421 and the cap 41 axially outwardly relative to the barrel 1, causing the annular retaining portion 411 of the cap 41 to be stopped at the bottom side of the top coupling flange 101 of the barrel 1. Thereafter, move the cap 41 axially downwardly toward the metal plate member 2 relative to the barrel 1 to force the lock screw 421 against the solder mask insert 3 and to further push the solder mask insert 3 out of the barrel 1.

Further, the periphery 32 of the solder mask insert 3 can be processed through a surface treatment to provide an anti-skid surface layer. The anti-skid surface layer can be made having an embossed pattern, evenly distributed raised portions or fine teeth, evenly distributed ribs, intersected ribs or the like that provide proper anti-skid function so that the solder mask insert 3 is prohibited from axial displacement relative to the bottom extension tube 113 after its insertion into the bottom extension tube 113. Further, press-fitting the solder mask insert 3 into the relatively narrower lower axial hole section 110 of the barrel 1 does not damage the inside wall of the bottom extension tube 113. Further, the outside wall of the solder mask insert 3 can be processed through a solder mask treatment, preventing adherence of the solder material 21 during the reflow soldering operation. Further, the cap 41 can be made having a plurality of longitudinal crevices 412 cut through the annular retaining portion 411. Subject to the effect of the longitudinal crevices 412, the annular retaining portion 411 of the cap 41 can be conveniently coupled to the periphery of the barrel 1. Further, the lock screw 421 can be made having a tool groove 4232 located on the center of the top wall of the head 423 and exposed to the outside of the cap 41. Further, the tool groove 4232 of the lock screw 421 can be a Phillipes groove, keystone groove, asterisk groove or hex groove so that a corresponding screwdriver or wrench can be used to rotate the lock screw 421 into the workpiece with less effort.

Further, the barrel 1, the spring 422 and the lock device 4 of the lock screw 421 and the cap 41 constitute a metal plate member fixation device for detachably fixing the metal plate member 2 to a shell 5. After removal of the solder mask insert 3 from the barrel 1, the metal plate member 2 is attached to the shell 5 to aim the mounting through hole 20 of the metal plate member 2 at a mounting screw hole 50 on the shell 5, and then drive the lock screw 421 into the mounting screw hole 50 of the shell 5 to lock the metal plate member 2 to the shell 5.

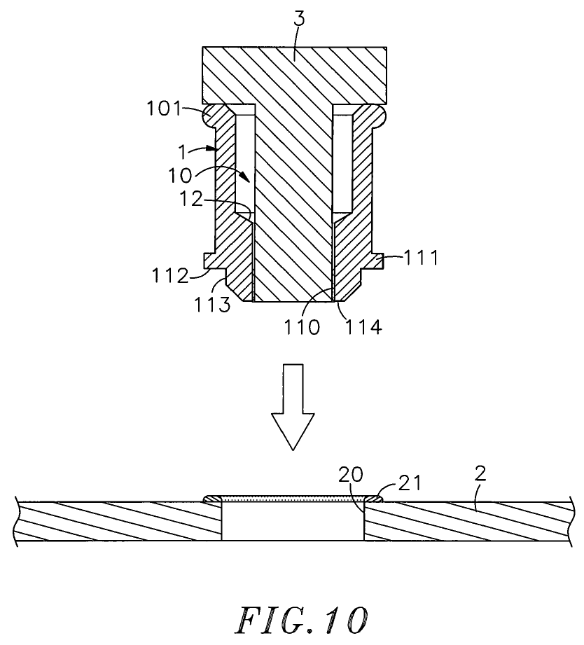

Referring to FIG. 10, the solder mask insert 3 can be shaped like a T-bar that can be inserted through the relatively wider upper axial hole section 10 of the barrel 1 and press-fitted into the relatively narrower lower axial hole section 110. After insertion of the solder mask insert 3 in the barrel 1, the transverse section of the T-shaped insert 3 is stopped at the top coupling flange 101 on the outside of the barrel 1, and the bottom edge of the longitudinal section of the T-shaped solder mask insert 3 is kept in flush with the bottom edge 114 of the bottom extension tube 113 of the barrel 1. When bonding the barrel 1 to the metal plate member 2, the solder mask insert 3 stops the melted solder material 21 from entering the relatively narrower lower axial hole section 110 of the barrel 1, avoiding damage to the inside wall of the barrel 1.

As stated above, a solder material overflow preventive metal plate member fixation device installation method in accordance with the invention is to press-fit a solder mask insert 3 into the relatively narrower lower axial hole section 110 of the barrel 1, forcing the periphery 32 of the solder mask insert 3 into friction engagement with the inside wall of the barrel 1 and keeping the bottom wall 31 of the solder mask insert 3 in flush with the bottom edge 114 of the bottom extension tube 113 of the barrel 1. When bonding the barrel 1 to the metal plate member 2 after insertion of the bottom extension tube 113 of the barrel 1 into the mounting through hole 20 of the metal plate member 2 and abutment of the bottom bonding surface 112 of the radially extended bottom bonding flange 111 of the barrel 1 against the solder material 21 at the metal plate member 2 around the mounting through hole 20, the solder mask insert 3 stops the melted solder material 21 from entering the relatively narrower lower axial hole section 110 of the barrel 1, avoiding deformation of the barrel 1 due to the effect of the high temperature of the melted solder material 21 and assuring a high level of installation quality.

In conclusion, the invention provides a solder material overflow preventive metal plate member fixation device installation method, which has the advantages and features as follows:
1. By means of press-fitting a solder mask insert 3 into the relatively narrower lower axial hole section 110 of the barrel 1, the solder mask 3 is prohibited from axial displacement relative to the barrel 1 and can effectively stop the melted solder material 21 from flowing into the relatively narrower lower axial hole section 110 of the barrel 1, preventing clogging of the relatively narrower lower axial hole section 110 of the barrel 1 by the solder material 21 and assuring a high level of bonding quality.
2. of press-fitting a solder mask insert 3 into the relatively narrower lower axial hole section 110 of the barrel 1, the solder mask 3 supports the barrel 1 against deformation during bonding of the barrel 1 to the metal plate member 2, assuring a high level of bonding quality and facilitating further installation performance of the metal plate member fixation device.

Although particular embodiments of the invention have been described in detail for purposes of illustration, various modifications and enhancements may be made without departing from the spirit and scope of the invention. Accordingly, the invention is not to be limited except as by the appended claims.

1. A solder material overflow preventive metal plate member fixation device installation method, comprising the steps of:
(a) preparing a barrel that comprises a bottom mounting unit having an axially extended bottom extension tube and a stepped axial hole extending axially through top and bottom sides of said barrel, and then inserting the bottom extension tube of said bottom mounting unit of said barrel into a mounting through hole on a metal plate member;
(b) abutting a bottom bonding surface of said bottom mounting unit of said barrel to a solder material on said metal plate member around said mounting through hole;
(c) press-fitting a solder mask insert into said stepped axial hole of said barrel to keep a bottom wall of said solder mask insert in flush with a bottom edge of the axially extended bottom extension tube of said barrel;
(d) applying a soldering process to melt said solder material and to further bond the bottom bonding flange of said barrel to said first metal plate member;
(e) removing said solder mask insert from said barrel; and
(f) ending the barrel installation procedure.

2. The solder material overflow preventive metal plate member fixation device installation method as claimed in claim 1, wherein said bottom mounting unit of said barrel comprises a radially extended bottom bonding flange around one end of said axially extended bottom extension tube; said bottom bonding surface is located on a bottom side of said radially extended bottom bonding flange perpendicular to said axially extended bottom extension tube.

3. The solder material overflow preventive metal plate member fixation device installation method as claimed in claim 1, wherein said stepped axial hole comprises a relatively wider upper axial hole section, a relatively narrower lower axial hole section and a step extending around an inside wall of said barrel between said relatively wider upper axial hole section and said relatively narrower lower axial hole section.

4. The solder material overflow preventive metal plate member fixation device installation method as claimed in claim 1, wherein said solder mask insert comprises an anti-skid surface layer for friction engagement with an inside wall of said barrel to prevent displacement of said solder mask insert relative to said barrel.

5. The solder material overflow preventive metal plate member fixation device installation method as claimed in claim 1, wherein said solder mask insert has the shape of a circular block.

6. The solder material overflow preventive metal plate member fixation device installation method as claimed in claim 1, wherein said solder mask insert has the shape of a T-bar.

7. A solder material overflow preventive metal plate member fixation device installation method, comprising the steps of:
(a) preparing a barrel that comprises a bottom mounting unit having an axially extended bottom extension tube and a stepped axial hole extending axially through top and bottom sides of said barrel, and then inserting the bottom extension tube of said bottom mounting unit of said barrel into a mounting through hole on a metal plate member;
(b) abutting a bottom bonding surface of said bottom mounting unit of said barrel to a solder material on said metal plate member around said mounting through hole;
(c) press-fitting a solder mask insert into said stepped axial hole of said barrel to keep a bottom wall of said solder mask insert in flush with a bottom edge of the axially extended bottom extension tube of said barrel;
(d) applying a soldering process to melt said solder material and to further bond the bottom bonding flange of said barrel to said first metal plate member;
(e) fastening a cap to a head of a lock screw and sleeving a spring member onto said lock screw, and then inserting said lock screw into said barrel to have said spring member be stopped between a part of said barrel and said head of said lock screw, and then axially slidably coupling said cap to said barrel;
(f) moving said cap relative to said barrel to force said lock screw against said solder mask insert and to further move said solder mask insert out of said barrel; and
(g) ending the barrel installation procedure.

8. The solder material overflow preventive metal plate member fixation device installation method as claimed in claim 7, wherein said bottom mounting unit of said barrel comprises a radially extended bottom bonding flange around one end of said axially extended bottom extension tube; said bottom bonding surface is located on a bottom side of said radially extended bottom bonding flange perpendicular to said axially extended bottom extension tube.

9. The solder material overflow preventive metal plate member fixation device installation method as claimed in claim 7, wherein said stepped axial hole comprises a relatively wider upper axial hole section, a relatively narrower lower axial hole section and a step extending around an inside wall of said barrel between said relatively wider upper axial hole section and said relatively narrower lower axial hole section for supporting one end of said spring member.

10. The solder material overflow preventive metal plate member fixation device installation method as claimed in claim 7, wherein said solder mask insert comprises an anti-skid surface layer for friction engagement with an inside wall of said barrel to prevent displacement of said solder mask insert relative to said barrel.

11. The solder material overflow preventive metal plate member fixation device installation method as claimed in claim 7, wherein said solder mask insert has the shape of a circular block.

12. The solder material overflow preventive metal plate member fixation device installation method as claimed in claim 7, wherein said solder mask insert has the shape of a T-bar.

13. The solder material overflow preventive metal plate member fixation device installation method as claimed in claim 7, wherein said cap defines therein an open chamber; said head of said lock screw comprises an engagement portion located on the periphery thereof and fixedly fastened to a part of said cap inside said open chamber.

14. The solder material overflow preventive metal plate member fixation device installation method as claimed in claim 7, wherein said lock screw comprises a tool hole located on a top wall of said head outside said cap in one of the forms of Phillipes groove, keystone groove, asterisk groove and hex groove for enabling said lock screw to be rotated with a screwdriver or wrench.

15. The solder material overflow preventive metal plate member fixation device installation method as claimed in claim 7, wherein said cap comprises at least one longitudinal crevice cut through the periphery thereof.

16. The solder material overflow preventive metal plate member fixation device installation method as claimed in claim 4, wherein the anti-skid surface layer includes at least one of an embossed pattern, evenly distributed raised portions or fine teeth, evenly distributed ribs, and intersected ribs.

17. The solder material overflow preventive metal plate member fixation device installation method as claimed in claim 10, wherein the anti-skid surface layer includes at least one of an embossed pattern, evenly distributed raised portions or fine teeth, evenly distributed ribs, and intersected ribs.

18. The solder material overflow preventive metal plate member fixation device installation method as claimed in claim 3, wherein the step is sloped to the axial direction of the axial hole.

19. The solder material overflow preventive metal plate member fixation device installation method as claimed in claim 9, wherein the step is sloped to the axial direction of the axial hole.
